(19) United States
(12) Patent Application Publication
(10) Pub. No.: US 2021/0267246 A1
(43) Pub. Date: Sep. 2, 2021

(54) COMPOSITION FOR DEGRADATION OF MYCOTOXIN COMPRISING ASPERGILLUS CULTURE FILTRATE AS EFFECTIVE COMPONENT AND USES THEREOF

(71) Applicant: SKYANGELBIO Corp., Seoul (KR)

(72) Inventors: Jaehyuk YU, Madison, WI (US); Ahmad Fakhri Mohammad ALSHANNAQ, Madison, WI (US); Dasol CHOI, Madison, WI (US)

(21) Appl. No.: 16/804,803

(22) Filed: Feb. 28, 2020

(51) Int. Cl. A23L 33/105; A23K 10/30; A23K 10/10

(52) U.S. Cl. CPC A23L 33/105; A23K 10/10; A23K 10/30

(57) ABSTRACT

A composition for degradation of mycotoxin includes Aspergillus culture filtrate as an effective component and uses thereof, and it is expected that, in the field of food products and animal feeds for which biodegradation of mycotoxin (in particular, aflatoxin) is required, and the composition can be advantageously used as a novel material that can maintain the activity of degrading mycotoxin even at high temperatures.

### TECHNICAL FIELD

The present invention relates to a composition for degradation of mycotoxin comprising Aspergillus culture filtrate as an effective component and uses thereof.

### BACKGROUND ART

Aflatoxins (AFs) are one type of the toxins of toxic molds, and they are difuranocoumarin derivatives produced by Aspergillus flavus, Aspergillus parasiticus, Aspergillus nomius, or the like of genus Aspergillus via polyketide pathway. Aflatoxins are detected from various kinds of agricultural food products, and are known to be a causal agent of the turkey X disease in 1960s. At present moment, about 20 types of aflatoxins are known, and, B1, B2, G1, and G2, which are the most important types among them, are widely found in nature. Aflatoxins are classified into Group 1 human carcinogens, and aflatoxin B1 is most commonly found and classified as the most acute and potent toxic carcinogen. After being activated by cytochrome P450 in human liver, aflatoxin B1 converts into aflatoxin B1-8,9-oxide, which binds to DNA for causing cancer. It is also known that aflatoxins cause a disturbance in reproduction-related hormones in cattle to yield sterility, miscarriage, or the like. As such, in many countries, strict management of aflatoxins is effected along with the regulations imposed on the maximum permissible level of aflatoxins in foods and animal feeds.

As a method for reducing aflatoxins, there are methods of chemical reduction, physical reduction, and biological reduction. For the crop production stage, storage stage after harvest, and storage stage after processing, the chemical reduction method has been mainly proposed while the physical reduction method is carried out mainly at the storage stage after harvest and also at the processing stage. However, once food products are contaminated with aflatoxins, it is quite difficult to remove the toxins, and, as the toxins are not degraded even by heating, development of a technique for effective inhibition of the production of aflatoxins is required.

Meanwhile, in Korean Patent Registration No. 2005433, “Streptomyces panaciradicis AF34 strain for degradaion of aflatoxin” is described, and, in Korean Patent Registration No. 0380535, “Method for control of aflatoxin using inhibitory microorganism CP220 and bean fermentation food and animal feed utilizing such microorganism” is described. However, there is no description included in those documents regarding the “composition for degradation of mycotoxin comprising Aspergillus culture filtrate as an effective component and uses thereof” of the present invention.

### DETAILED DESCRIPTION OF THE INVENTION

### Technical Problems to be Solved

The present invention is devised under the circumstances described above, and the inventors of the present invention found that the culture filtrate of a strain belonging to genus Aspergillus has an excellent degrading activity for aflatoxin as a mycotoxin, and, as a result of analyzing the degrading activity for aflatoxin at various temperature conditions after preparing a culture filtrate with modification of the composition of glucose, nitrate, or trace elements in the culture filtrate to optimize the degrading activity for aflatoxin, it was found that, by adjusting the content of iron among trace elements, the culture filtrate of Aspergillus strain of the present invention can have increased aflatoxin-degrading activity, and the aflatoxin degradation is enhanced in temperature dependent manner, and the present invention is completed accordingly.

### Technical Means for Solving the Problems

To solve the problems described in the above, the present invention provides a composition for degradation of mycotoxin comprising Aspergillus culture filtrate as an effective component.

The present invention further provides a method for degradation of mycotoxin including treating a sample suspected to contain mycotoxin with the aforementioned composition.

The present invention further provides a method for production of Aspergillus culture filtrate having an activity of degrading mycotoxin including:

(a) inoculating Aspergillus conidia to a culture medium followed by culturing; and

(b) filtering a culture broth of the Aspergillus of above (a).

The present invention further provides an Aspergillus culture filtrate having an activity of degrading mycotoxin that is produced by the aforementioned method.

The present invention further provides a food additive comprising the aforementioned composition for degradation of mycotoxin of the present invention.

The present invention still further provides an animal feed additive comprising the aforementioned composition for degradation of mycotoxin of the present invention.

### Advantageous Effect of the Invention

Compared to techniques of a related art, the composition for degradation of mycotoxin according to the present invention can degrade aflatoxins with higher efficiency, and, as the activity of degrading mycotoxin is maintained in very stable state even under heating conditions like 121° C., it is expected that the composition of the present invention can be advantageously used for processings like treatment at high temperatures. Accordingly, it is expected that, in the field of food products and animal feeds for which biodegradation of mycotoxin (in particular, aflatoxin) is required, the composition of the present invention can be advantageously used as a novel material that can maintain the activity of degrading mycotoxin even at high temperatures.

### BRIEF DESCRIPTION OF THE DRAWINGS

FIG. 1 is a diagram showing the process of producing D-Tox.

FIG. 2A and FIG. 2B show the result of analyzing the aflatoxin-degrading activity of D-Tox depending on reaction temperature and time, in which FIG. 2A shows the result of determining the aflatoxin-degrading activity of D-Tox at different time points (aflatoxin was 5,000 ppb) and FIG. 2B shows the result of determining the aflatoxin-degrading activity of D-Tox on different day (aflatoxin was 1,500 ppb).

FIG. 3 shows the result of analyzing the aflatoxin-degrading activity of D-Tox under high temperature conditions (100° C.).

FIG. 4 shows the result of analyzing the aflatoxin-degrading activity of Aspergillus oryzae and various Aspergillus strains, in which the reduced amount of aflatoxin after a reaction with 10 ppm aflatoxin for 24 hours at 30° C. was calculated compared to chromatogram area of the initial concentration.

FIG. 5 shows the result showing the aflatoxin-degrading activity of D-Tox after removal of trace elements.

FIGS. 6A and 6B show a graph showing the aflatoxin-degrading activity of D-Tox A_{0.5} (½ composition of D-Tox A) and D-Tox A_{0.25} (composition of D-Tox A except that glucose and sodium nitrate are ½, and trace elements are ¼ of D-Tox A), which are separately added with ferrous sulfate, and also the result of pH measurement.

FIG. 7 shows the result of analyzing the aflatoxin-degrading activity of D-Tox A_{0.25}R2.5 for 1,000 or 5,000 ppb aflatoxin.

FIGS. 8A, 8B, 8C and 8D show result of analyzing the aflatoxin-degrading activity of D-Tox A_{0.25}R2.5 for 50 ppb aflatoxin(D), 100 ppb aflatoxin(C), 500 ppb aflatoxin(B) or 1,000 ppb aflatoxin(A) at room temperature.

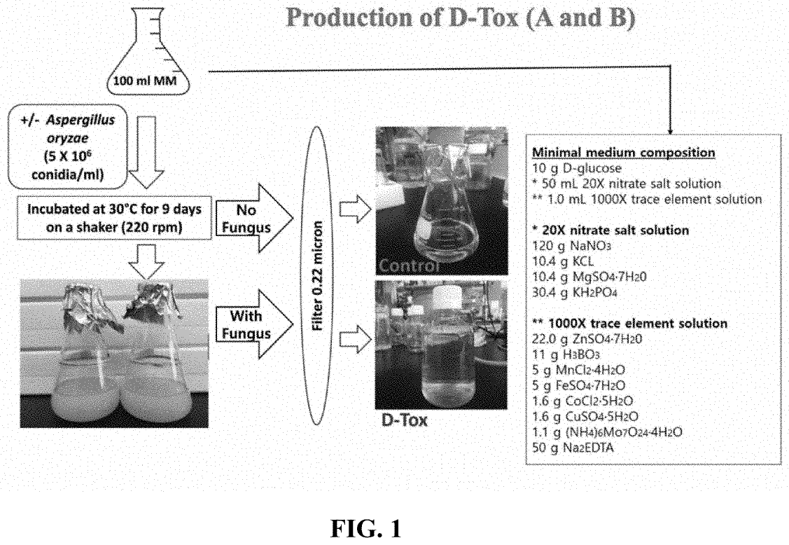

### BEST MODE (S) FOR CARRYING OUT THE INVENTION

To achieve the object of the present invention, the present invention provides a composition for degradation of mycotoxin comprising Aspergillus culture filtrate as an effective component.

With regard to the composition for degradation of mycotoxin according to the present invention, the Aspergillus culture filtrate may be a culture filtrate that is prepared by a method including (a) inoculating Aspergillus conidia to a culture medium followed by culturing; and (b) filtering a culture broth of the Aspergillus of above (a), but it is not limited thereto.

Furthermore, with regard to the composition for degradation of mycotoxin according to the present invention, the Aspergillus strain can be Aspergillus oryzae (A. oryzae), Aspergillus terreus (A. terreus), Aspergillus sojae (A. sojae), Aspergillus nidulans (A. nidulans), Aspergillus fumigatus (A. fumigatus), or Aspergillus flavus (A. flavus), but it is not limited thereto. The culture filtrate of those strains is characterized by its remarkably excellent activity of degrading mycotoxin compared to a culture filtrate derived from other Aspergillus species. Specifically, when the culture filtrate of each of the above fungal strains is reacted with aflatoxin B1 (10 ppm) for 24 hours at 30° C., the aflatoxin-degrading activity of at least 80% was shown from the all strains.

With regard to the composition for degradation of mycotoxin according to the present invention, the mycotoxin can be aflatoxin, ochratoxin, fumonisin, zearalenone, deoxynivalenol, trichothecene, or patulin, and preferably aflatoxin, but it is not limited thereto.

Furthermore, as the composition for degradation of mycotoxin according to the present invention is characterized in that it exhibits the activity of degrading mycotoxin in a temperature range of 20 to 150° C., and preferably in a temperature range of 20 to 130° C., it can be applied in a broad temperature range. In addition, the function of the composition can be stably exhibited even under a heat treatment process with temperature of more than 100° C., it can be industrially used with very high usefulness.

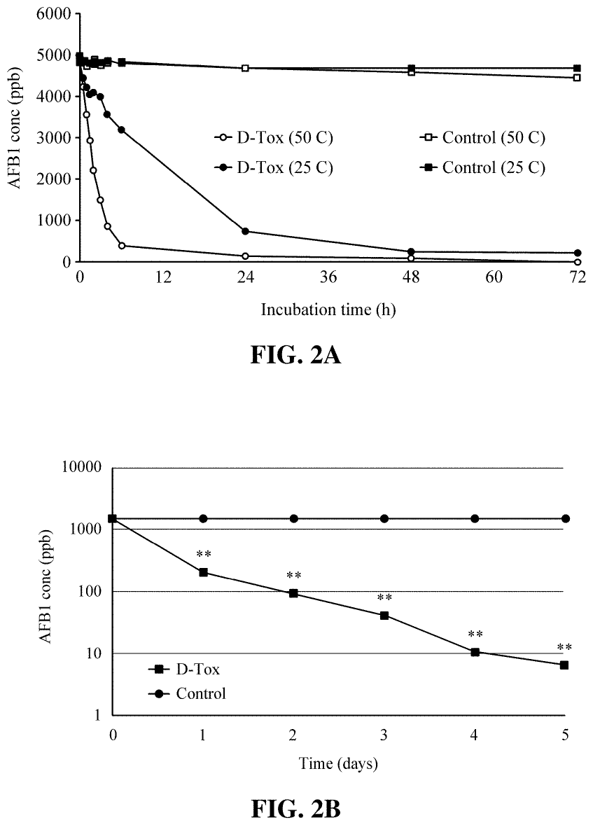

Furthermore, according to the result of examining the activity of degrading the reference material AFB1 (aflatoxin B1), the composition for degradation of mycotoxin of the present invention showed the degradation activity of 90% for 1.5 ppm AFB1 for 24 hours at 50° C. and the degradation activity of 99% for 100 ppm AFB1 for 60 minutes at 100° C. (see. FIG. 2A-2B).

With regard to the composition for degradation of mycotoxin according to one embodiment of the present invention, the Aspergillus culture filtrate can be a sterile cell-free culture broth which has been obtained by inoculating Aspergillus oryzae conidia at final concentration of 10⁴ to 10⁷ conidia/ml of 90 to 110 ml culture medium, carrying out culture for 6 to 10 days at 30° C. under shaking at 220 rpm, removing mycelia from the culture broth, and filtering the resultant using a filter unit for sterilization, but it is not limited thereto.

The present invention further provides a method for degradation of mycotoxin including treating a sample suspected to contain mycotoxin with the composition of the present invention.

With regard to the method for degradation of mycotoxin according to the present invention, the composition comprises, as an effective component, Aspergillus culture filtrate which has an activity of degrading mycotoxin, and the details thereof are the same as those described in the above.

Furthermore, with regard to the method for degradation of mycotoxin according to the present invention, the mycotoxin is the same as those described in the above, and the sample suspected to contain mycotoxin can be an agricultural product, a processed food product, or an animal feed, but it is not limited thereto.

The present invention further provides a method for production of Aspergillus culture filtrate having an activity of degrading mycotoxin including:

(a) inoculating Aspergillus conidia to a culture medium followed by culturing; and

(b) filtering a culture broth of the Aspergillus of above (a),

and also an Aspergillus culture filtrate having an activity of degrading mycotoxin that is produced by the aforementioned method.

Furthermore, with regard to the production method of the present invention, the Aspergillus can be A. oryzae, A. terreus, A. sojae, A. nidulans, A. fumigatus, or A. flavus, but it is not limited thereto.

Furthermore, the conidia of above (a) can be inoculated, at a concentration of from 10⁴ to 10⁷ conidia/ml, to a culture medium composed of glucose, nitrate, and trace elements, and preferably can be inoculated to a culture medium at a concentration of 5×10⁶ conidia/ml and cultured for 6 to 10 days under shaking at 30° C., but it is not limited thereto.

Furthermore, with regard to the production method according to one embodiment of the present invention, the culture medium can be a medium which is composed of glucose, sodium nitrate (NaNO₃), magnesium sulfate⋅heptahydrate (MgSO₄.7H₂O), potassium chloride (KCl), potassium phosphate (KH₂PO₄), zinc sulfate⋅heptahydrate (ZnSO₄.7H₂O), boric acid (H₃BO₃), manganese chloride⋅tetrahydrate (MnCl₂.4H₂O), ferrous sulfate⋅heptahydrate (FeSO₄.7H₂O), cobalt chloride⋅pentahydrate (CoCl₂.5H₂O), copper sulfate⋅pentahydrate (CuSO₄.5H₂O), ammonium molybdate⋅tetrahydrate ((NH₄)₆Mo₇O₂₄.4H₂O) and disodium salt of ethylenediaminetetraacetic acid (Na₂EDTA),

preferably a medium composed of 1 to 20 g of glucose, 1 to 10 g of sodium nitrate, 0.1 to 1.0 g of magnesium sulfate⋅heptahydrate, 0.1 to 1.0 g of potassium chloride, 0.1 to 2.0 g of potassium phosphate, 1 to 30 mg of zinc sulfate⋅heptahydrate, 1 to 20 mg of boric acid, 1 to 10 mg of manganese chloride⋅tetrahydrate, 0.1 to 300 mg of ferrous sulfate⋅heptahydrate, 0.1 to 2.0 mg of cobalt chloride⋅pentahydrate, 0.1 to 2.0 mg of copper sulfate⋅pentahydrate, 0.1 to 2.0 mg of ammonium molybdate⋅tetrahydrate, and 5 to 60 mg of disodium salt of ethylenediaminetetraacetic acid per liter of unit volume of the culture broth,

more preferably a medium composed of 3 to 12 g of glucose, 1 to 7 g of sodium nitrate, 0.2 to 0.55 g of magnesium sulfate⋅heptahydrate, 0.2 to 0.55 g of potassium chloride, 0.5 to 1.7 g of potassium phosphate, 3 to 25 mg of zinc sulfate⋅heptahydrate, 2 to 12 mg of boric acid, 1 to 6 mg of manganese chloride⋅tetrahydrate, 1 to 270 mg of ferrous sulfate⋅heptahydrate, 0.3 to 1.7 mg of cobalt chloride⋅pentahydrate, 0.3 to 1.7 mg of copper sulfate⋅pentahydrate, 0.2 to 1.2 mg of ammonium molybdate⋅tetrahydrate, and 10 to 52 mg of disodium salt of ethylenediaminetetraacetic acid per liter of unit volume of the culture broth,

even more preferably a medium composed of 4 to 6 g of glucose, 2 to 4 g of sodium nitrate, 0.2 to 0.3 g of magnesium sulfate⋅heptahydrate, 0.2 to 0.3 g of potassium chloride, 0.7 to 0.8 g of potassium phosphate, 5 to 6 mg of zinc sulfate⋅heptahydrate, 2.5 to 3 mg of boric acid, 1 to 1.5 mg of manganese chloride⋅tetrahydrate, 1.25 to 3 mg of ferrous sulfate⋅heptahydrate, 0.3 to 0.5 mg of cobalt chloride⋅pentahydrate, 0.3 to 0.5 mg of copper sulfate⋅pentahydrate, 0.25 to 0.3 mg of ammonium molybdate⋅tetrahydrate, and 12 to 13 mg of disodium salt of ethylenediaminetetraacetic acid per liter of unit volume of the culture broth, and

most preferably a medium composed of 5 g of glucose, 3 g of sodium nitrate, 0.25 g of magnesium sulfate⋅heptahydrate, 0.25 g of potassium chloride, 0.75 g of potassium phosphate, 5.5 mg of zinc sulfate⋅heptahydrate, 2.75 mg of boric acid, 1.25 mg of manganese chloride⋅tetrahydrate, 2.5 mg of ferrous sulfate⋅heptahydrate, 0.4 mg of cobalt chloride⋅pentahydrate, 0.4 mg of copper sulfate⋅pentahydrate, 0.275 mg of ammonium molybdate⋅tetrahydrate, and 12.5 mg of disodium salt of ethylenediaminetetraacetic acid per liter of unit volume of the culture broth, but it is not limited thereto.

The present invention further provides a food additive comprising the composition for degradation of mycotoxin according to the present invention. When the composition for degradation of mycotoxin according to the present invention is used as a food additive, the composition for degradation of mycotoxin may be either directly added or used in combination with other food ingredients, and it can be suitably used according to a common method. The blending amount of the effective component can be suitably set depending on the purpose of use thereof.

Type of the food product is not particularly limited. Examples of a food product to which the aforementioned material may be added include meat products, sausages, bread, chocolate, candies, snacks, cookies, pizza, ramen, other noodles, gums, dairy products including ice cream, various soups, beverages, tea, drinks, alcohol beverages and vitamin complexes, and all food products in general sense are included therein.

The present invention still further provides an animal feed additive comprising the composition for degradation of mycotoxin according to the present invention.

As the composition for degradation of mycotoxin according to the present invention comprises Aspergillus culture filtrate having an excellent property of degrading aflatoxin as mycotoxin, it enables good health state and improved bodyweight gain amount of livestock, and thus the composition can be advantageously used as an effective component of an animal feed additive.

The animal feed additive of the present invention and an animal feed comprising the same may be used with, as an auxiliary component, a material like amino acids, inorganic salts, vitamins, antibiotics, antimicrobial substances, antioxidizing, antimold enzymes, agents for improving digestion and absorption, growth promoting agents, or agents for preventing diseases.

The animal feed additive may be administered to an animal either singly or in combination with other animal feed additives in edible carrier. Furthermore, the animal feed additive can be applied as a top dressing or directly blended in an animal feed. Alternatively, separate from an animal feed, it can be easily administered, in the form of separate oral formulation, by injection or transdermal administration in combination with other components. In general, single daily dosage or divided daily dosage may be taken as it is well known in the pertinent art. When the animal feed additive is administered separately from an animal feed, the administration form of an extract can be prepared, according to combination with non-toxic pharmaceutically acceptable edible carrier, in an immediate-release formulation or a delayed-release formulation, as it is well known in the pertinent art. Examples of the edible carrier include solids and liquids such as corn starch, lactose, sucrose, bean flake, peanut oil, olive oil, sesame oil, or propylene glycol. In case of using a solid carrier, the administration form of an extract can be a tablet, a capsule, a powder, a troche, or a sugar-containing tablet, or top dressing in non-dispersion form. In case of using a liquid carrier, it may have administration form like soft gelatin capsule, syrup, liquid suspension, emulsion, or solution. Furthermore, the administration form may also include an aid such as preservative, stabilizer, wetting agent, emulsifier, or dissolution promoter.

The term “D-Tox” used herein means a composition showing excellent activity of degrading aflatoxin as mycotoxin, in which the composition is a cell-free culture filtrate of Aspergillus strain grown in food-grade medium containing human-safe edible chemicals (glucose, nitrates, minerals, cofactors, and the like). Characteristics of D-Tox according to the present invention are as described in the following Table 1.

TABLE 1
Characteristics of D-Tox

| Specifications | D-Tox | Other technologies |
|---|---|---|
| Percentage of reduction % | 90-99% | Up to 70-85% |
| Heat and processing stability | Stable | Not stable |
| Aflatoxin degradation ability | Up to 100 ppm | 0.1 to 5 ppm |
| Protein/non-protein based | Non-protein based | Protein based |
| Single/multiple usability | Multiple | Single |
| Time required for | Short e.g., | Long e.g., |
| degradation/removal | 20 min | days |
| Types of AF detoxification | Irreversible, | Reversible, |
| reactions | destructed | or binding |
| Manufacturing scale-up | Simple, cost- | Not easy, |
| | effective | expensive |
| Recyclable/Environmentally | Yes | No |
| friendly product | | |

Hereinbelow, the present invention is explained in greater detail in view of the Examples. However, it is evident that the following Examples are given only for exemplification of the present invention and by no means the present invention is limited to the following Examples.

### Materials and Methods

1. Culture of Aspergillus Strains

Various Aspergillus strains have been used for determining the ability to produce D-Tox (i.e., cell-free culture fermentate with aflatoxin-degrading activity), and all the strains were cultured and maintained on potato dextrose agar (PDA) medium (containing 4 g potato starch, 20 g glucose, and 15 g agar in 1 L of distilled water) at 4° C. To prepare inoculum, Aspergillus was grown on PDA for 7 days at 30° C. After that, asexual spores (i.e., conidia) were harvested from the PDA medium by using sterile 0.1% Tween-80 solution. The conidia were counted by using a hemocytometer and adjusted to 10⁸ conidia/ml with sterile distilled water. Conidia suspension was stored at 4° C. and used within 2 weeks after the preparation.

2. Composition of Medium for Producing D-Tox

For preparing the full strength culture medium, 10.0 g D-glucose, 50 ml of 20× sodium nitrate solution, and 1.0 ml of 1,000× solution of trace elements were mixed and dissolved in 600 ml distilled water. After adjusting to the final volume of 1,000 ml, stirring was carried out at least for 20 minutes, and then pH was adjusted to pH 6.5 using sodium chloride. Then, according to sterilization under high pressure (50 psi for 20 minutes at 121° C.), the full strength culture medium was prepared. The 20× sodium nitrate solution and 1,000× solution of trace elements that are used for preparing the medium were prepared as described in the following Table 2.

TABLE 2
Composition of sodium nitrate solution and trace element solution
20 × Sodium nitrate solution (in 1 liter)

| | |
|---|---|
| Sodium nitrate (NaNO₃) | 120.0 g |
| Magnesium sulfate- heptahydrate (MgSO₄ · 7H₂O) | 10.4 g |
| Potassium chloride (KCl) | 10.4 g |
| Potassium phosphate (KH₂PO₄) | 30.4 g |

1,000 × Trace element solution (in 1 liter)

| | |
|---|---|
| Zinc sulfate-heptahydrate (ZnSO₄ · 7H₂O) | 22.0 g |
| Boric acid (H₃BO₃) | 11.0 g |
| Manganese chloride- tetrahydrate (MnCl₂ · 4H₂O) | 5.0 g |
| Ferrous sulfate-heptahydrate (FeSO₄ · 7H₂O) | 5.0 g |
| Cobalt chloride-pentahydrate (CoCl₂ · 5H₂O) | 1.6 g |
| Copper sulfate-pentahydrate (CuSO₄ · 5H₂O) | 1.6 g |
| Ammonium molybdate-tetrahydrate ((NH₄)₆Mo₇O₂₄ · 4H₂O) | 1.1 g |
| Disodium salt of ethylenediaminetetraacetic | 50.0 g |
| acid (Na₂EDTA) | |

Furthermore, composition of a culture medium for producing D-Tox in which compositions of glucose, sodium nitrate, and trace elements are changed, and type of D-Tox according to those compositions are as described in the following Table 3.

TABLE 3
Type and composition of D-Tox

| D-Tox | D-Tox | | |
|---|---|---|---|
| Type | Name | Culture media composition | Notes |
| D-Tox A | D-Tox A | 10.0 g D-glucose, | |
| | | 50.0 ml 20 × | |
| | | sodium nitrate solution, | |
| | | 1.0 ml 1,000 × | |
| | | trace element solution | |
| D-Tox A | D-Tox | 5.0 g D-glucose, | 1/2 |
| | A_{0.5} | 25.0 ml 20 × | Composition |
| | | sodium nitrate solution, | of D-Tox A |
| | | 0.5 ml 1,000 × | |
| | | trace element solution | |
| D-Tox | D-Tox | 5.0 g D-glucose, | Composition |
| AR | A_{0.25}R25 | 25.0 ml 20 × | of D-Tox A |
| | | sodium nitrate solution, | with adjusted |
| | | 0.25 ml 1,000 × | iron content |
| | | trace element solution, + | in which |
| | | ferrous sulfate- | glucose and |
| | | heptahydrate 2.5 | sodium |
| | | ppm (final) | nitrate are |
| | | | 1/2, and trace |
| | | | elements |
| | | | are 1/4 |
| | | | of D-Tox A |
| D-Tox | D-Tox | 5.0 g D-glucose, | |
| AR | A_{0.25}R25 | 25.0 ml 20 × | |
| | | sodium nitrate solution, | |
| | | 0.25 ml 1,000 × | |
| | | trace element solution, + | |
| | | ferrous sulfate- | |
| | | heptahydrate 25 | |
| | | ppm (final) | |
| D-Tox | D-Tox | 5.0 g D-glucose, | |
| AR | A_{0.25}R250 | 25.0 ml 20 × | |
| | | sodium nitrate solution, | |
| | | 0.25 ml 1,000 × | |
| | | trace element solution, + | |
| | | ferrous sulfate- | |
| | | heptahydrate 250 | |
| | | ppm (final) | |

* Control: Relevant D-Tox culture medium treated similarly, without fungal inoculation

Summary of the composition of culture medium for preparing D-Tox A, which is used in the present invention based on the description of the above Table 3, is as shown in the following Table 4.

TABLE 4
Composition of D-Tox a culture medium (in 1 liter)

| | D-Tox A | | D-Tox A_{0.5} | | D-Tox A_{0.25} | | D-Tox A_{0.25}R2.5 | | D-Tox A_{0.25}R25 | | D-Tox A_{0.25}R250 | |
|---|---|---|---|---|---|---|---|---|---|---|---|---|
| Glucose | 10 | g | 5 | g | 5 | g | 5 | g | 5 | g | 5 | g |
| NaNO₃ | 6 | g | 3 | g | 3 | g | 3 | g | 3 | g | 3 | g |
| MgSO₄ · 7H₂O | 0.5 | g | 0.25 | g | 0.25 | g | 0.25 | g | 0.25 | g | 0.25 | g |
| KCl | 0.5 | g | 0.25 | g | 0.25 | g | 0.25 | g | 0.25 | g | 0.25 | g |
| KH₂PO₄ | 1.5 | g | 0.75 | g | 0.75 | g | 0.75 | g | 0.75 | g | 0.75 | g |
| ZnSO₄ · 7H₂O | 22 | mg | 11 | mg | 5.5 | mg | 5.5 | mg | 5.5 | mg | 5.5 | mg |
| H₃BO₃ | 11 | mg | 5.5 | mg | 2.75 | mg | 2.75 | mg | 2.75 | mg | 2.75 | mg |
| MnCl₂ · 4H₂O | 5 | mg | 2.5 | mg | 1.25 | mg | 1.25 | mg | 1.25 | mg | 1.25 | mg |
| FeSO₄ · 7H₂O | 5 | mg | 2.5 | mg | 1.25 | mg | 2.5 | mg | 25 | mg | 250 | mg |
| CoCl₂ · 5H₂O | 1.6 | mg | 0.8 | mg | 0.4 | mg | 0.4 | mg | 0.4 | mg | 0.4 | mg |
| CuSO₄ · 5H₂O | 1.6 | mg | 0.8 | mg | 0.4 | mg | 0.4 | mg | 0.4 | mg | 0.4 | mg |
| (NH₄)₆Mo₇O₂₄ · 4H₂O | 1.1 | mg | 0.55 | mg | 0.275 | mg | 0.275 | mg | 0.275 | mg | 0.275 | mg |
| Na₂EDTA | 50 | mg | 25 | mg | 12.5 | mg | 12.5 | mg | 12.5 | mg | 12.5 | mg |

3. Preparation of D-Tox

Aspergillus oryzae conidia were inoculated into a culture medium (100 ml) to have a final concentration of 5×10⁶ conidia/ml and incubated for 9 days at 30° C. with shaking at 220 rpm. The mycelia were separated from the culture broth by filtration with four layers of Miracloth (MilliporeSigma) and the sterile cell-free culture fermentate (D-Tox) was obtained by filtering through 0.22 μm PES filter unit (Thermo Scientific, USA). D-Tox was kept at 4° C.

4. Preparation of Aflatoxin

A powder of AFB1 (aflatoxin B1) was purchased from Sigma Chemical Co. (St. Louis, Mo., USA). Standard solutions of AFB1 were prepared in acetonitrile at a final concentration of 10 μg/ml according to the AOAC (Association of Official Analytical Chemists) method. Thus-prepared solutions were stored at −20° C. in amber glass vials.

5. Degradation of Aflatoxin B1 (AFB1) by D-Tox

AFB1 (10 μl) at a concentration of 50 to 5,000 ppb (parts per billion) was added to D-Tox (20 ml). Then, after allowing the reaction to occur at various temperature and time conditions, degradation level of AFB1 was analyzed. As a control group, distilled water was added in the same amount as D-Tox and used. All the test group and control group were tested in a triplicate manner, and the degradation level of AFB1 was evaluated based on HPLC (high-performance liquid chromatography) analysis. AFB1 peak was recorded by using ChemStation software (Agilent, USA).

TABLE 5
HPLC condition

| | |
|---|---|
| Equipment | Agilent 1100 HPLC system |
| | (degasser, autosampler, quaternary |
| | pump, coupled with a diode |
| | array detector, |
| | fluorescence detector) |
| Column | Zorbax Eclipse XDB-C18 |
| | 4.6 mm × 150 mm, 3.5 μm. |
| Detection | 365 nm for UV detection, |
| wavelength | 365 nm excitation and 450 nm |
| | emission for FLD detection |
| Mobile phase | H₂O:CH₃OH:CH₃CN (50:40:10) |
| Flow rate | 0.8 ml/min |
| Injection volume | 100 μl |

It is also known that the lactone of AFB1 generally undergoes ring opening in strong basic state (pH 10 to 12), and, if the pH is lowered when no further degradation occurs, the lactone ring of AFB1 is restored to yield the toxin in original form. The inventors of the present invention named this phenomenon “reforming”, and, to examine any further degradation of AFB1 after the lactone ring opening by D-Tox, they made the determination according to the following method. D-Tox sample was subjected to a reaction with AFB1 followed by heating for 60 minutes at 100° C., and, after 24 hours, the resulting sample was added with 6 N hydrochloric acid to adjust the pH to 2 to 3 and the reaction was allowed to occur for 4 hours at room temperature. After that, the reforming of AFB1 in original form with restored lactone ring was evaluated by HPLC analysis.

### Example 1. Analysis of Aflatoxin-Degrading Activity of D-Tox Depending on Various Reaction Temperature and Time Conditions

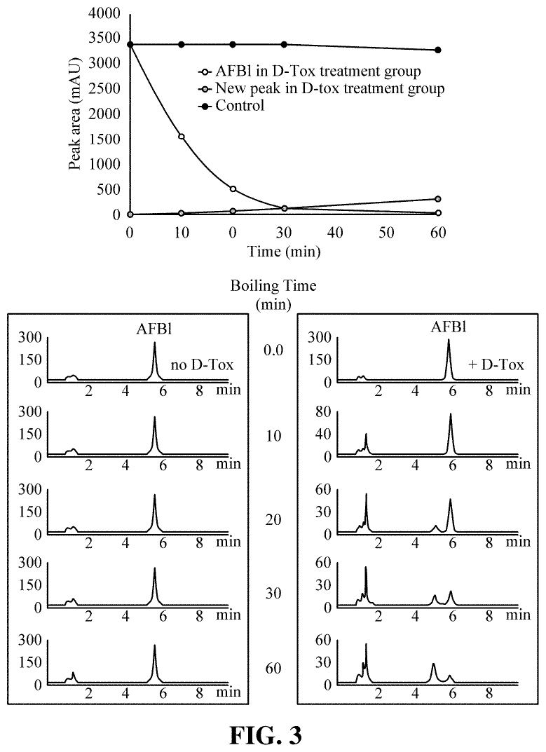

The inventors analyzed the degradation level of AFB1 when AFB1 (5,000 ppb) was reacted with D-Tox A (prepared by using Aspergillus oryzae NRRL3483) for 72 hours at 25° C. or 50° C. In addition, the prolonged activity was evaluated when AFB1 (1,500 ppb) was reacted with D-Tox A for 5 days at 30° C. As a result, it was found that the AFB1-degrading activity of D-Tox A is directly correlated with the reaction temperature and time (FIGS. 2a and 2b). It was observed that more than 90% of AFB1 was degraded after 24 hours at the reaction temperature of 50° C., and, it was also found that, at the reaction temperature of 25° C., 89% of AFB1 was degraded after 48 hours. Furthermore, when D-Tox A is treated with AFB1 (100,000 ppb) followed by heating for 10 minutes, it was shown that 50% of AFB1 was degraded while 96% of AFB1 was degraded after heating for 30 minutes (FIG. 3). On the other hand, AFB1 of the control group, which has not been treated with any D-Tox A, maintained a stable state without showing any degradation even under heating conditions.

### Example 2. Analysis of Aflatoxin-Degrading Activity of D-Tox Derived from Various Strains

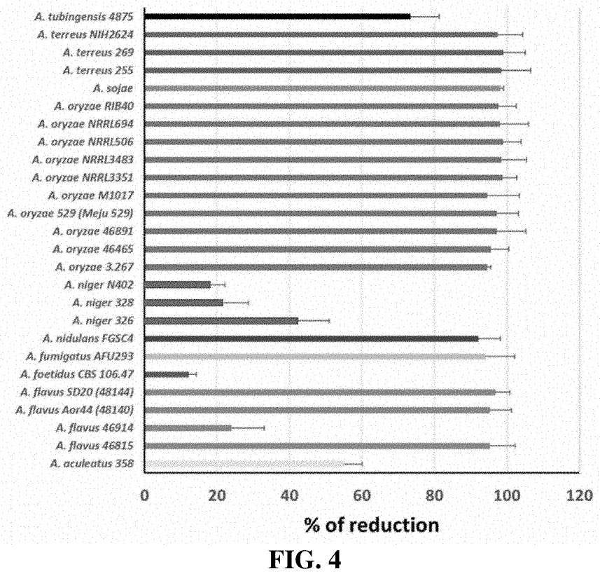

The aflatoxin-degrading activity was compared among various Aspergillus oryzae strains and other Aspergillus strains. As a result, as it is illustrated in FIG. 4, it was found that an excellent aflatoxin-degrading effect is shown from D-Tox which has been prepared by using various Aspergillus oryzae strains and other Aspergillus strains (for example, A. terrus, A. sojae, A. nidulans, A. fumigatus, and A. flavus).

### Example 3. Optimization of Use Amount of Trace Elements and D-Tox Activity

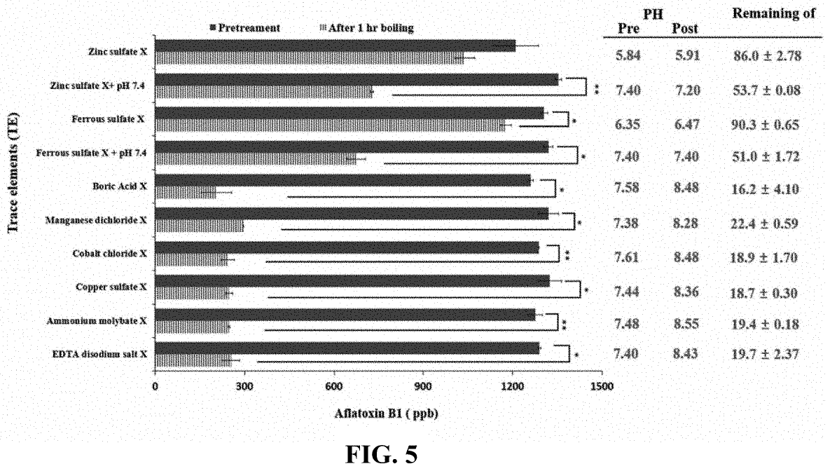

To minimize the use amount of the trace elements and optimize the D-Tox activity in Aspergillus culture broth, a series of knocked-out experiment was carried out by the inventors of the present invention. As a result, it was found that, for 1.0 ppm AFB1, the degrading activity of D-Tox lacking trace elements was 78 to 83% on average and the degrading activity of D-Tox lacking ferrous sulfate and zinc sulfate was 10 to 15% (FIG. 5). Furthermore, to produce D-Tox with reduced use amount of raw materials and by an environmentally friendly method, the composition of D-Tox A was cut by half, thus yielding D-Tox A_{0.5}. As a result of measuring dry mass after culturing Aspergillus strain in the above composition, it was shown that the degrading activity for AFB1 (90% or higher) showed no difference in significance sense when compared to D-Tox A, although the cell growth rate is lower than before.

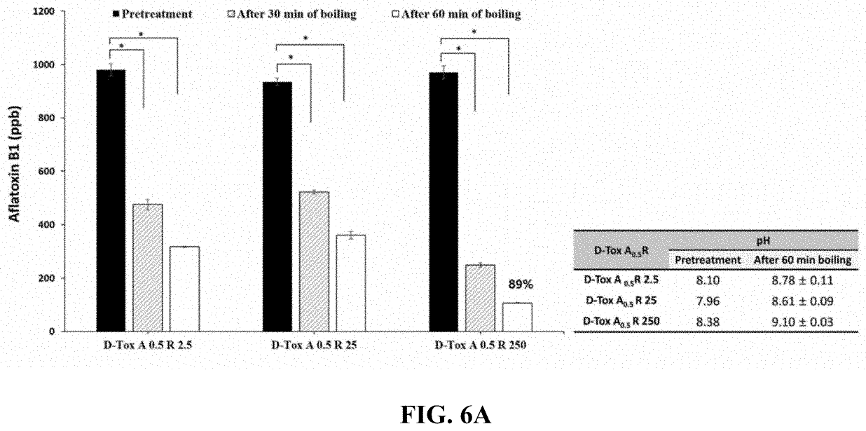

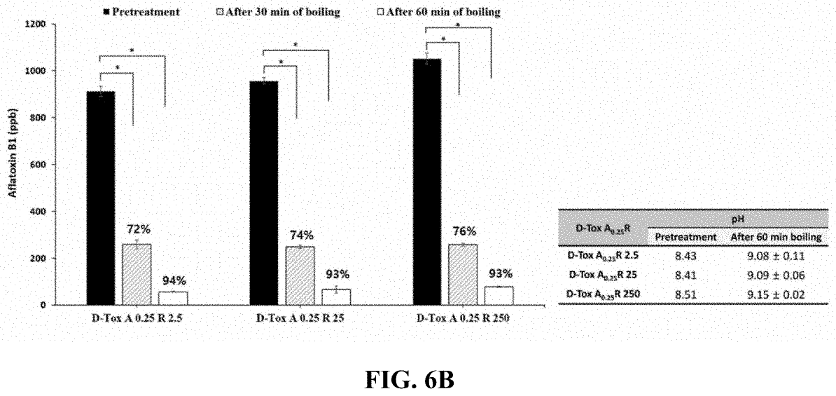

Furthermore, the degrading activity for AFB1 was compared among D-Tox AR series which have been prepared by further adding, as a trace element, ferrous sulfate to a culture medium. D-Tox A_{0.5}R means a culture filtrate prepared by using ½ composition of D-Tox A with a culture medium with adjusted ferrous sulfate content, and D-Tox A_{0.25}R means a culture filtrate prepared by using glucose and sodium nitrate in ½ composition of D-Tox A and trace elements in ¼ composition of D-Tox A with a culture medium with adjusted ferrous sulfate content (see, Table 4). Ferrous sulfate⋅heptahydrate was added such that the final concentration per unit volume of the culture medium is 2.5, 25, or 250 ppm. The D-Tox A series was reacted with 1 ppm AFB1 and, after heating for 30 minutes or 60 minutes at 100° C., the degradation level of AFB1 was evaluated by an HPLC analysis. As a result, as it is shown in FIG. 6A, D-Tox A_{0.5} test group (D-Tox A_{0.5}R250) prepared with a culture medium containing 250 ppm ferrous sulfate showed the high AFB1-degradding activity of 89% after heating for 60 minutes. However, the AFB1 degradation level at other conditions (i.e., D-Tox A_{0.5}R2.5 and D-Tox A_{0.5}R25) showed no difference in significance sense according to varying content of ferrous sulfate. On the other hand, D-Tox A_{0.25}R test group prepared with a culture medium containing ferrous sulfate at final concentration of 2.5, 25 or 250 ppm showed very high AFB1-degradding activity of 93 to 94% after heating for 60 minutes (FIG. 6B), and thus showing an enhanced AFB1-degrading activity compared to D-Tox A_{0.5}R test group. In particular, as a result of measuring, for every test group, the pH of reaction solution after heating for 60 minutes, increased pH compared to pH before the reaction was shown from D-Tox A_{0.5}R250, D-Tox A_{0.25}R2.5, D-Tox A_{0.25}R25 and D-Tox A_{0.25}R250 test groups which have exhibited the excellent AFB1-degrading activity. Based on these results, it was recognized that, based on adjusted iron content, D-Tox A_{0.25} shows more excellent effect of enhancing the AFB1-degrading activity compared to D-Tox A_{0.5}, and, in case of having higher iron content in D-Tox A_{0.25}, the AFB1-degrading activity can be effectively enhanced with the concentration of 2.5 ppm only.

### Example 4. Determination of Aflatoxin-Degrading Activity of D-Tox AR

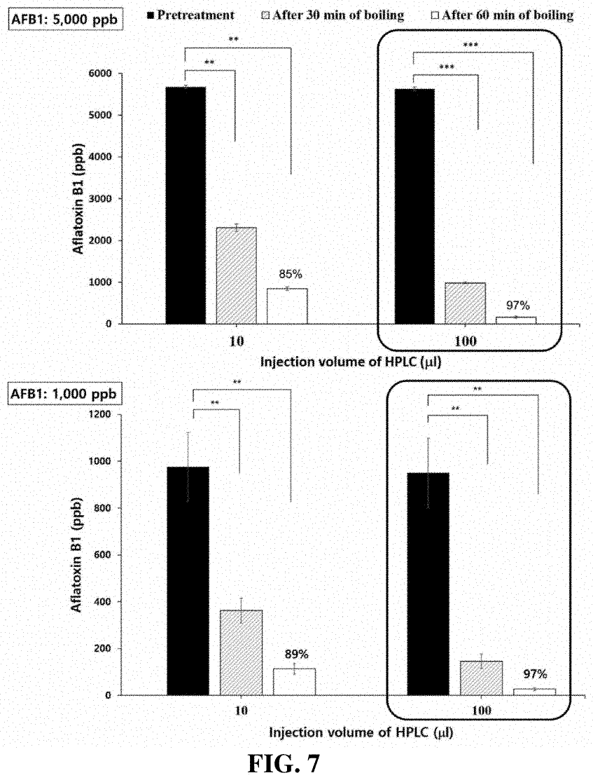

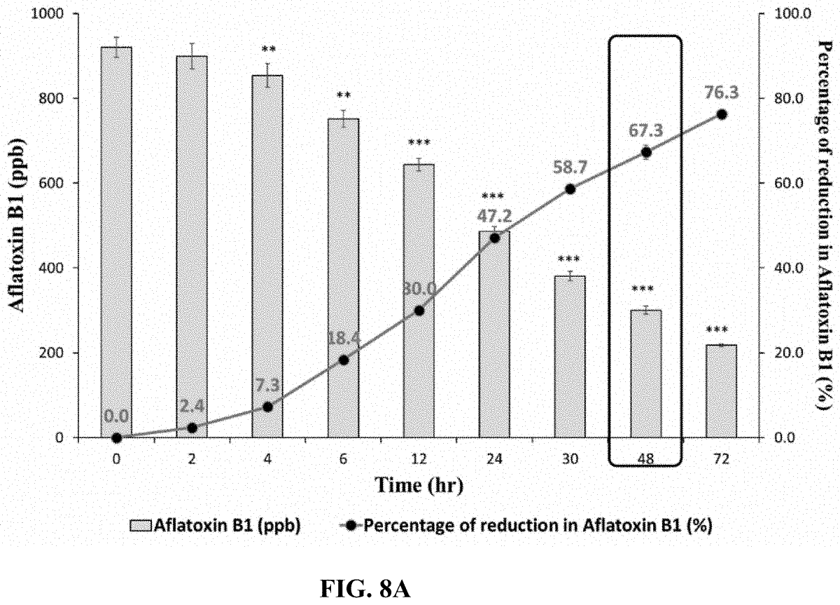

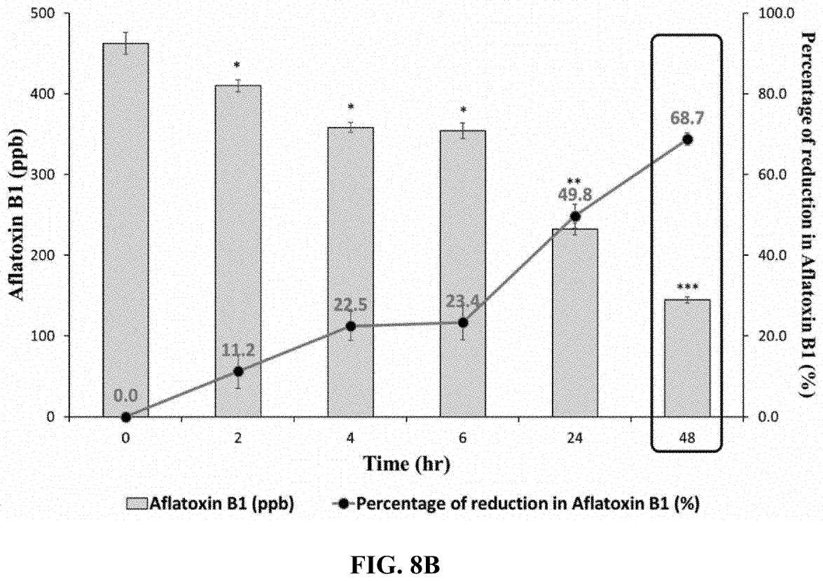

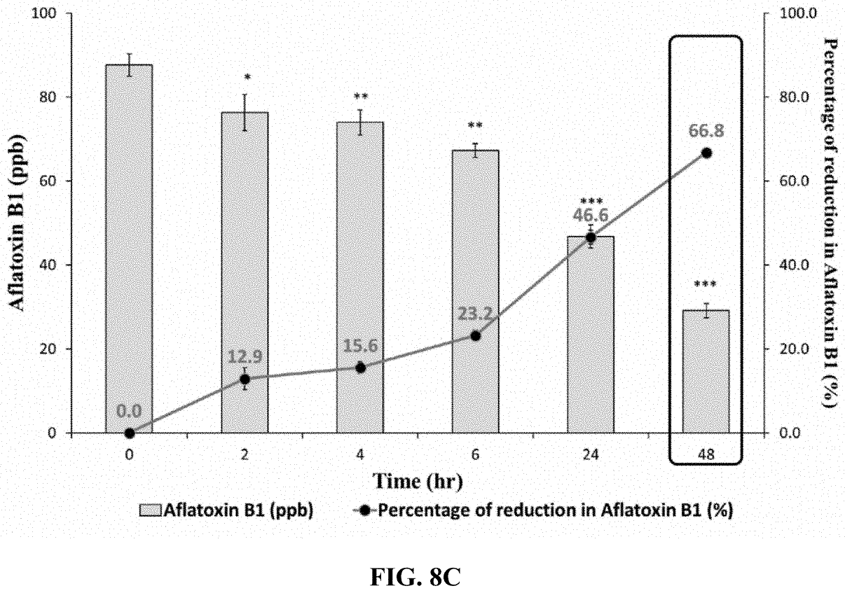

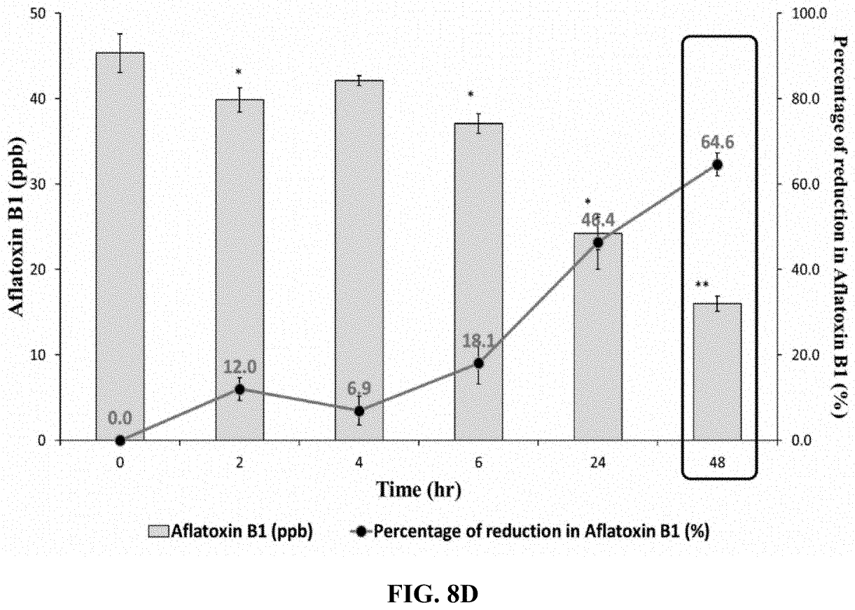

The aflatoxin-degrading of D-Tox A_{0.25}R2.5 was examined by the inventors of the present invention by using 1,000 or 5,000 ppb AFB1. First, conidia concentration of Aspergillus oryzae NRRL 3483 was adjusted to 10⁴ conidia/ml, inoculated to 100 ml culture medium (see, Table 4), and cultured for 9 days at shaking rate of 220 rpm at 30° C. to prepare D-Tox A_{0.25}R2.5. After that, D-Tox A_{0.25}R2.5 was reacted with AFB1 and heated for 30 minutes or 60 minutes at 100° C., and the AFB1-degrading activity was evaluated by an HPLC analysis. Furthermore, for the HPLC analysis, a sample of each test group was collected in an injection amount of 10 μl or 100 μl and the residual amount of AFB1 was analyzed. As a result, as it is illustrated in FIG. 7, it was found that D-Tox A_{0.25}R2.5 exhibited an excellent degrading activity even for 5,000 ppb (=5 ppm) AFB1. In addition, as a result of analyzing the degrading activity of D-Tox A_{0.25}R2.5 for AFB1 at room temperature, it was found that 66 to 69% of AFB1 was degraded after 48 hours (FIGS. 8A-8D). Furthermore, when 1 ppm AFB1 was added to D-Tox A_{0.25}R2.5, allowed to stand for 60 minutes in a water bath set at 37° C., 100° C., or 121° C., and the degrading activity was analyzed by measuring the amount of residual AFB1, it was found that, at 37° C. condition, AFB1 has remained with almost no degradation even after 60 minutes as described in Table 6. However, at 100° C. condition, AFB1-degrading activity of 64% and 86% was shown 30 minutes and 60 minutes after the reaction, respectively, and, at 120° C. condition, no AFB1 was detected after 30 minutes, indicating the complete degradation. Based on these results, it was recognized that D-Tox A_{0.25}R2.5 has temperature-dependent ABF1 degrading activity.

TABLE 6
AFB1-degrading activity of D-Tox
A_{0.25}R2.5 depending on reaction temperature

| | | Aflatoxin B1 (ppm) | | |
|---|---|---|---|---|
| Reaction time | | 0 min | 30 min | 60 min |
| Reaction | 37° C. | 1.08 | 0.83 | 0.98 |
| temperature | 100° C. | 0.92 | 0.33 | 0.13 |
| | 121° C. | 0.92 | 0 | 0 |

Summary of the AFB1-degrading activity of various D-Tox types described in Table 3 (i.e., result obtained from 1-hour reaction at 100° C. using 1 ppm AFB1) is given in the following Table 7.

TABLE 7
AFB1-degrading activity for different types of D-Tox

| D-Tox | D-Tox | AFB1-degrading | Reform |
|---|---|---|---|
| Type | Name | activity (%) | (%) |
| D-Tox A | D-Tox A | 71.5 ± 2.59 | 0 |
| | D-Tox | 70.9 ± 1.28 | 6.44 ± 5.96 |
| | A_{0.05} | | |
| D-Tox | D-Tox | 93.8 ± 1.11 | — |
| AR | A_{0.25}R2.5 | | |
| | D-Tox | 93.0 ± 0.11 | — |
| | A_{0.25}R25 | | |
| | D-Tox | 92.6 ± 1.68 | — |
| | A_{0.25}R250 | | |

1. A composition for degradation of mycotoxin comprising Aspergillus culture filtrate as an effective component.

2. The composition for degradation of mycotoxin according to claim 1, wherein the Aspergillus culture filtrate is prepared by a method including:
(a) inoculating Aspergillus conidia to a culture medium followed by culturing; and
(b) filtering a culture broth of the Aspergillus of above (a).

3. The composition for degradation of mycotoxin according to claim 1, wherein the Aspergillus is Aspergillus oryzae, Aspergillus terreus, Aspergillus sojae, Aspergillus nidulans, Aspergillus fumigatus, or Aspergillus flavus.

4. The composition for degradation of mycotoxin according to claim 1, wherein the mycotoxin is aflatoxin, ochratoxin, fumonisin, zearalenone, deoxynivalenol, trichothecene, or patulin.

5. The composition for degradation of mycotoxin according to claim 1, wherein the composition exhibits an activity of degrading mycotoxin at a temperature of 20 to 150° C.

6. A method for degradation of mycotoxin including treating a sample suspected to contain mycotoxin with the composition of claim 1.

7. The method for degradation of mycotoxin according to claim 6, wherein the mycotoxin is aflatoxin, ochratoxin, fumonisin, zearalenone, deoxynivalenol, trichothecene, or patulin.

8. The method for degradation of mycotoxin according to claim 6, wherein the sample suspected to contain mycotoxin is an agricultural product, a processed food product, or an animal feed.

9. A method for production of Aspergillus culture filtrate having an activity of degrading mycotoxin including:
(a) inoculating Aspergillus conidia to a culture medium followed by culturing; and
(b) filtering a culture broth of the Aspergillus of above (a).

10. The method for production of Aspergillus culture filtrate having an activity of degrading mycotoxin according to claim 9, wherein the Aspergillus is Aspergillus oryzae, Aspergillus terreus, Aspergillus sojae, Aspergillus nidulans, Aspergillus fumigatus, or Aspergillus flavus.

11. The method for production of Aspergillus culture filtrate having an activity of degrading mycotoxin according to claim 9, wherein the culture medium consists of glucose, nitrates, and trace elements.

12. The method for production of Aspergillus culture filtrate having an activity of degrading mycotoxin according to claim 11, wherein the culture medium contains 0.1 to 300 mg of iron element per liter of unit volume of culture medium.

13. The method for production of Aspergillus culture filtrate having an activity of degrading mycotoxin according to claim 9, wherein the mycotoxin is aflatoxin, ochratoxin, fumonisin, zearalenone, deoxynivalenol, trichothecene, or patulin.

14. An Aspergillus culture filtrate having an activity of degrading mycotoxin that is produced by the method of claim 9.

15. A food additive comprising the composition for degradation of mycotoxin of claim 1.

16. An animal feed additive comprising the composition for degradation of mycotoxin of claim 1.
